(19) United States
(12) Patent Application Publication
(10) Pub. No.: US 2020/0118012 A1
(43) Pub. Date: Apr. 16, 2020

(54) Monitoring the Thermal Health of an Electronic Device

(71) Applicant: Hewlett-Packard Development Company, L.P., Spring, TX (US)

(72) Inventors: Nailson Boaz Costa Leite, Porto Alegre (BR); Augusto Queiroz de Macedo, Porto Alegre (BR); John Landry, Houston, TX (US)

(73) Assignee: Hewlett-Packard Development Company, L.P., Spring, TX (US)

(21) Appl. No.: 16/603,851

(22) PCT Filed: Apr. 18, 2017
(86) PCT No.: PCT/US2017/028114

§ 371 Date: Oct. 9, 2019

(51) Int. Cl. G06N 5/04; G06N 20/20; G06N 5/00; G01K 3/08

(52) U.S. Cl. CPC G06N 5/04; G01K 3/08; G06N 5/003; G06N 20/20

(57) ABSTRACT

A system for monitoring the thermal health of an electronic device is described. The system includes a predictor to predict an expected temperature of the electronic device using a model. The system also includes a computation manager to compute a difference between an actual temperature of the electronic device and the expected temperature, compute a z-score of the difference, and map the z-score to a thermal health grade for the electronic device.

### BACKGROUND

The temperature of an electronic device is determined by retained heat. Retained heat is the difference between generated heat and dissipated heat. The thermal behavior of an electronic device is strongly related to the device's platform type. However, other factors also contribute to an electronic device's thermal behavior. These factors include usage of the electronic device and external factors such as the surface supporting the electronic device, ambient temperature, or humidity, among others.

### DESCRIPTION OF THE DRAWINGS

Certain examples are described in the following detailed description and in reference to the drawings, in which:

FIG. 1 is a schematic diagram of a process for monitoring the thermal health of an electronic device in accordance with examples of the present techniques;

FIG. 2 is a bar chart showing the relative importance of fan speed, battery usage, and CPU usage when monitoring the thermal health of an electronic device in accordance with examples of the present techniques;

FIG. 3 is a histogram of the differences between the actual and expected temperatures when monitoring the thermal health of an electronic device in accordance with examples of the present techniques;

FIG. 4 is a table for mapping a z-score to a thermal health grade when monitoring the thermal health of an electronic device in accordance with examples of the present techniques;

FIG. 5 is a block diagram of a system for monitoring the thermal health of an electronic device in accordance with examples of the present techniques;

FIG. 6 is a block diagram of a system for monitoring the thermal health of an electronic device in accordance with examples of the present techniques;

FIG. 7 is a process flow diagram of a method for monitoring the thermal health of an electronic device in accordance with examples of the present techniques;

FIG. 8 is a process flow diagram of a method for monitoring the thermal health of an electronic device in accordance with examples of the present techniques;

FIG. 9 is a block diagram of a medium containing code to execute monitoring of the thermal health of an electronic device in accordance with examples of the present techniques; and

FIG. 10 is an example of monitoring the health of an electronic device in accordance with examples of the present techniques.

### DETAILED DESCRIPTION

Techniques for monitoring the thermal health of an electronic device are discussed herein. For example, a system for monitoring the thermal health may predict an expected temperature of the electronic device. To perform this function, a difference between the actual temperature of the electronic device and the expected temperature may be computed. A z-score may be computed for the difference between the actual temperature and the expected temperature, and mapped to a thermal health grade for the electronic device.

In certain situations, the electronic device may have inadequate heat dissipation. These situations may result in uncomfortable handling or a shortening of the lifespan of the electronic device.

The techniques described herein may use electronic device data and machine learning techniques to train a model to evaluate the thermal health of a device. In particular, a trained model results in a thermal health grade for an electronic device based on the thermal properties of the device. The grade given the electronic device may become worse as the heat dissipation becomes more inadequate. The techniques discussed herein may be used to detect when an electronic device may be serviced. As such, the techniques discussed herein may extend the lifespan of the electronic device.

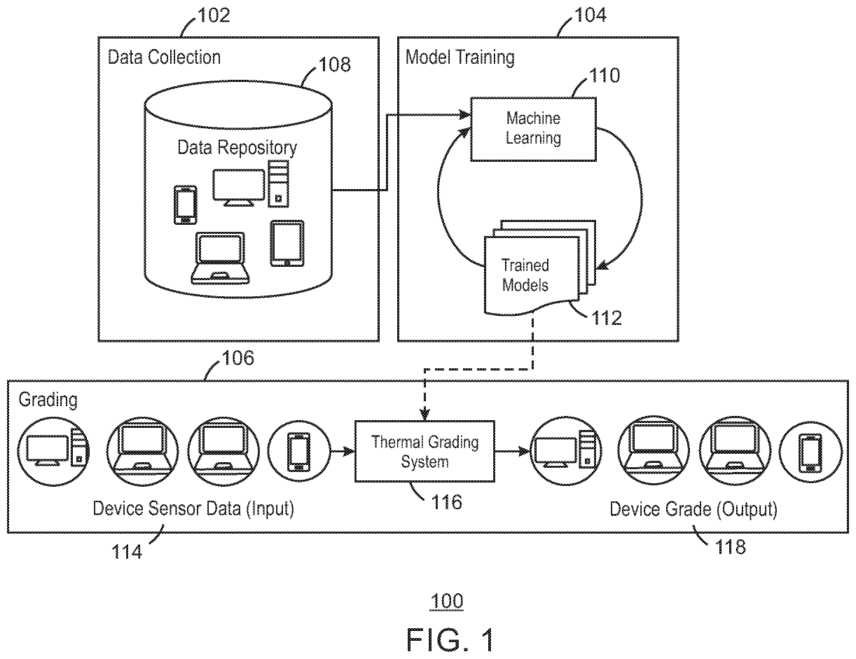

FIG. 1 is a schematic diagram of a process 100 for monitoring the thermal health of an electronic device. The process 100 may have three phases, data collection 102, model training 104, and grading 106. During data collection 102, data may be collected from electronic devices in the field and stored in a data repository 108. Data may be collected from a variety of electronic device platforms. These platforms may include desktop computers, laptop computers, tablets, smartphones, and the like. In some examples, data may be collected for a group of devices in a product line.

The data collected during data collection 102 may be of two types, descriptive features and instrument features. The descriptive features may include such things as device platform, form factor, cooling system, CPU model, and a number of CPUs in the device. These descriptive features may be used to group the data of devices with similar physical characteristics. Knowing the device platform or product line may be useful for classifying an electronic device into an appropriate group. Otherwise, knowing the form factor, cooling system, and CPU model may be enough to group an electronic device.

The instrument features may include the data received from sensors that detect the temperature of an electronic device and other parameters that influence the thermal behavior of the device over time. These other parameters may include CPU usage, fan speed, battery usage, battery temperature, device age, and GPU usage, among others. For example, CPU usage and GPU usage may be expressed as a percentage of the time the CPU or GPU is in use, the fan speed may be provided on a scale from 0 to 100, and the battery usage may be true or false depending on whether the battery is in use or not.

Different device sensors may be offered by different manufacturers. Better thermal health grading may result if more sensors are available to detect the different parameters affecting the thermal health of an electronic device. For example, a more accurate thermal health grade may be obtained if an electronic device has sensors for CPU usage, fan speed, battery usage, and device age than if the electronic device only has sensors for CPU usage and device age. Furthermore, more frequent sampling may result in improved confidence in the thermal health grade for an electronic device. For example, samples collected hourly may provide a more accurate thermal health grade than samples collected daily.

In model training 104, machine learning 110 may result in trained models 112. Machine learning methods may include decision tree learning, association rule learning, neural networks, deep learning, inductive logic programming, support vector machines, clustering, Bayesian networks, reinforcement learning, representation learning, similarity and metric learning, sparse dictionary learning, rule-based machine learning, and learning classifier systems. For example, decision tree learning uses a decision tree as a predictive model which maps observations about an item, represented by the branches, to conclusions about the item's target value, represented by the leaves.

Decision trees where the target variable can take on continuous values, such as the temperature of an electronic device, are called regression trees. Decision tree learning may result in a random forest model. A random forest model may be linear or non-linear. Other types of models may be obtained using other machine learning methods. The other types of models may be static, dynamic, explicit, implicit, discrete, continuous, deterministic, probabilistic, deductive, inductive, or floating.

Using machine learning 110, a model may be trained to predict the temperature of an electronic device based on CPU usage, fan speed, and battery usage. For example, a random forest model may have a multitude of predictive trees constructed at training time and output the mean prediction of the individual regression trees. The mean prediction may be the temperature of an electronic device.

Like some decision tree models, the random forest model can accept non-numeric data types, such as Boolean variables, such as battery usage, and categorical variables, including, for example, form factor. However, the random forest model may generalize to unforeseen situations. In addition, the random forest model may learn more parameters and accommodate a more complex target feature. Furthermore, the random forest model has the flexibility to rank the parameters by impact on the target feature. For example, the random tree model may rank fan speed, battery usage, and CPU usage by impact on the temperature of an electronic device.

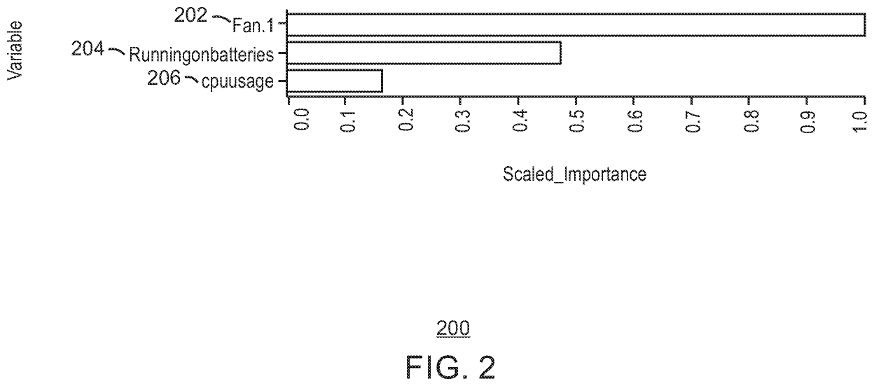

FIG. 2 is a bar chart showing the relative importance of fan speed 202, battery usage 204, and CPU usage 206 when monitoring the thermal health of an electronic device. These results were obtained using a random forest model trained on all data in a data repository for a certain type of device platform. For a given platform, fan speed 202 may be an important predictor of device temperature. An analysis like that shown in FIG. 2 may be used to identify heat dissipation problems with a given platform in the field.

Returning to FIG. 1, a trained model 112 may be developed for each device platform type or product line. The techniques described herein may automatically update the trained model 112 for each platform type or product line by training the trained model 112 and evaluating accuracy metrics at a certain frequency. For example, updating may occur on a weekly basis, a monthly basis, a quarterly basis, or at other selected timeframes. The updating may keep the trained models 112 current by taking into consideration possible thermal behavior changes caused by such things as aging or fan speed degradation. The updating may also develop a training model 112 for newly encountered device platforms or product lines.

The root mean square error (RMSE) may be computed for the trained models 112 using a cross-validation train-test partitioning. The RMSE is the sample standard deviation of the differences between the actual temperatures and the temperatures predicted by the trained model 112 for a certain device platform or product line. The technique of computing RMSE using cross-validation train-test partitioning provides an estimate of model prediction performance. The technique involves partitioning a sample of data into complementary or non-overlapping subsets, computing the RMSE for one subset called the training set, and validating the RMSE on the other subset called the testing set. A maximum acceptable RMSE may be used to decide if a trained model 112 is accurate enough to be used in grading 106.

To be reliable, a grading model may be trained on a minimum number of different device platforms or product lines. Also, a reliable grading model may be trained on a minimum number of devices for each type of device platform or product line. For example, a grading model may be reliable if trained using at least 15 days of daily data collections per device and at least 30 different types of device platforms or product lines.

The trained model 112 may represent the thermal behavior of a device platform or product line. The trained model 112 may generalize to new device platforms or product lines. However, a new device platform or product line may suffer from the cold start problem, i.e., a lack of information about the new device platform or product line. Models may be applied hierarchically following the device product hierarchy to avoid the cold start problem. For example, there may be models for platforms X, Y, and Z. Platform X may not enough data records to train a model. There may be a second model trained on all platforms of the same form factor, for example, platforms Y and Z. The second model may generalize to platform X. If the second model does not generalize, there may be a model for the platform family that generalizes to platform X. Movement up the hierarchy may continue until a model that generalizes to platform X is found.

The trained model 112 may predict the average temperature given all possible device conditions expressed as instrument features. By calculating the difference between the actual temperature and the predicted temperature, it may be possible to grade the thermal health of an electronic device. However, if a single temperature difference is calculated, the thermal health grade may be inaccurate because of data noise and changes in device usage. To correct for these inaccuracies, the differences between the actual temperatures from the last N data records and the model predictions may be calculated and averaged. From the average of the differences, a z-score may be calculated and mapped to a thermal device grade. FIG. 1 depicts this grading 106 process. Device sensor data 114 may be input to a thermal grading system 116. The thermal grading system 116 may use the trained model 112 for the particular platform or product line to predict the expected temperatures from the last N sets of device sensor data 114. The differences between the actual temperatures included in the last N sets of sensor data and the expected temperatures may be calculated by the thermal grading system 116. A z-score for the average of the differences may be calculated and the z-score mapped to a thermal health grade. The device grade 118 may be output from the thermal grading system 116.

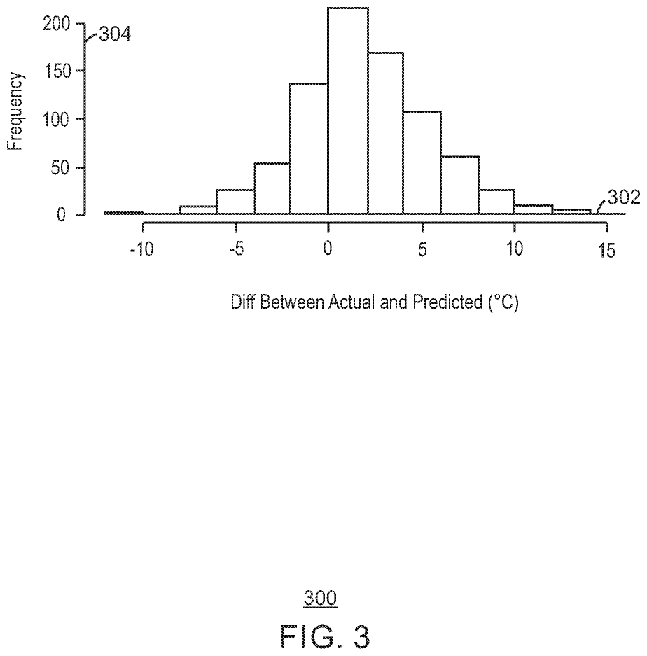

The trained models 112 may have low RMSEs, so it may be assumed that the differences between the actual temperatures and the expected temperatures may follow a Gaussian distribution such as that depicted in FIG. 3. The Gaussian distribution shown in FIG. 3 is a histogram 300 of the differences between the actual and expected temperatures for a particular model. The x-axis 302 represents the difference between the actual and predicted temperatures in degrees Celsius. The y-axis 304 represents the frequency or number of times a temperature difference occurred. For example, the difference between the actual and predicted temperatures was 0-2° C. in excess of 200 times. Certain features of a Gaussian distribution may make it possible to determine a health grade for an electronic device.

The z-score can be calculated for Gaussian distributions. A z-score is the number of standard deviations a data point is above or below the average value of what is being measured. For the techniques described herein, a z-score is the number of standard deviations that the average difference between actual and predicted temperatures for N data records is above or below the average value for the temperature difference for all electronic devices in a data repository of a certain platform type or product line. A z-score is calculated using Eqn. 1.

z-score=(x−μ)/σ Eqn. 1

In Eqn. 1, the term x represents the average difference between the actual and predicted temperatures for N data records. The term μ represents the distribution average, the average of the differences between the actual and expected temperatures, for all the devices in the data repository that share the same platform or product line. The term σ represents the standard deviation for the distribution.

As an example, a z-score of 3.0 for the average difference between the actual and predicted temperatures for the last N data records is 3.0 standard deviations to the right of the distribution average. A z-score of −2.2 for the average difference between the actual and predicted temperatures for the last N data records is 2.2 standard deviations to the left of the distribution average.

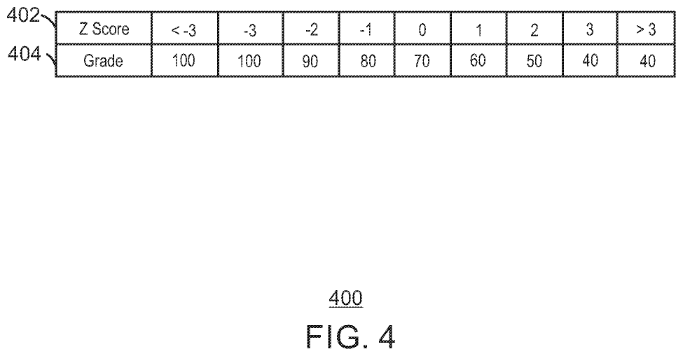

After computing the z-score, the thermal health grade of an electronic device may be determined by mapping the z-score to a value based on a function or a table like the one shown in FIG. 4. The first row 402 of the table 400 is the z-score and the second row 404 is the thermal health grade. For example, a z-score of approximately 2.0 corresponds to a thermal health grade of 50. Higher thermal health grades indicate that the electronic device in question may be in better thermal health. A thermal health grade of 50 may indicate that preventive maintenance may be performed on the device, although other levels may be used to indicate this, such as 30%, or 70%, among others. The selection may be based on the importance of the electronic device, among other factors.

The thermal health grade for the electronic device may be on a scale from 0 to 100 as shown in FIG. 4. However, any scale may do, as long as it is clear whether a higher grade or a lower grade indicates better thermal health. For example, a scale from 0 to 1 may be used.

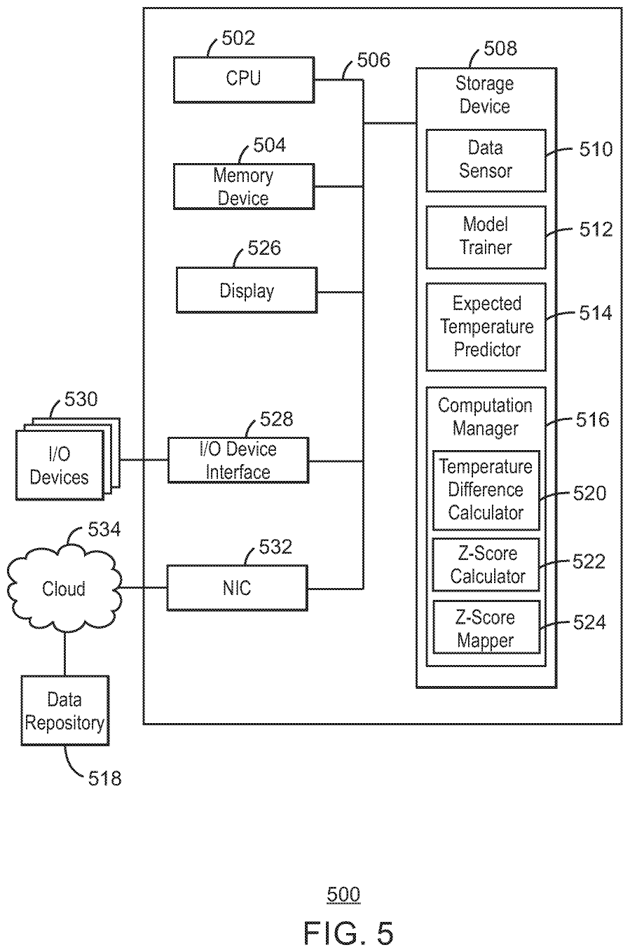

FIG. 5 is a block diagram of a system 500 for monitoring the thermal health of an electronic device. The system 500 may include a central processing unit (CPU) 502 for executing stored instructions. The CPU 502 may be more than one processor, and each processor may have more than one core. The CPU 502 may be a single core processor, a multi-core processor, a computing cluster, or other configurations. The CPU 502 may be a microprocessor, a processor emulated on programmable hardware, e.g., FPGA, or other types of hardware processor. The CPU 502 may be implemented as a complex instruction set computer (CISC) processor, a reduced instruction set computer (RISC) processor, an X86 instruction set compatible processor, or other microprocessor or processor.

The system 500 may include a memory device 504 that stores instructions that are executable by the CPU 502. The CPU 502 may be coupled to the memory device 504 by a bus 506. The memory device 504 may include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory system. The memory device 504 can be used to store data and computer-readable instructions that, when executed by the processor 502, direct the processor 502 to perform various operations in accordance with embodiments described herein.

The system 500 may also include a storage device 508. The storage device 508 may be a physical memory device such as a hard drive, an optical drive, a flash drive, an array of drives, or any combinations thereof. The storage device 508 may store data as well as programming code such as device drivers, software applications, operating systems, and the like. The programming code stored by the storage device 508 may be executed by the CPU 502.

The storage device 508 may include a data sensor 510, a model trainer 512, an expected temperature predictor 514, and a computation manager 516. The data sensor 510 may accomplish the tasks associated with data collection 102 in FIG. 1. The model trainer 512 may accomplish the tasks associated with model training 104 in FIG. 1. The expected temperature predictor 514 and the computation manager 516 may accomplish the tasks associated with grading 106 in FIG. 1.

The data sensor 510 may detect the temperature of an electronic device and other parameters that influence the device's thermal behavior over time. The data may be collected and stored in data records. A data record may include temperature, CPU usage, fan speed, and battery use of the electronic device. The data records may be stored in a data repository 518.

The model trainer 512 may train a model using the data records from the data repository 518. Using machine learning, a model may be trained to predict the temperature of an electronic device based on CPU usage, fan speed, and battery usage. There are a number of machine learning techniques that may be used to train a variety of models. For example, a random forest model may be trained by constructing a multitude of decision trees. A model may be trained for each type of device platform or product line.

The expected temperature predictor 514 may use the trained model for the appropriate device platform or product line to predict the expected temperature of an electronic device. The trained model may use the CPU usage, fan speed, and battery usage to predict the expected temperature. For a random forest model, the expected temperature is the mean prediction of the individual trees constructed during the machine learning phase.

The computation manager 516 may determine the thermal health grade for an electronic device. To accomplish this, the computation manager 516 may include a temperature difference calculator 520, a z-score calculator 522, and a z-score mapper 524. The temperature difference calculator 520 may calculate the difference between the actual temperatures of the last N data records and the model predictions. The average of the N differences between the actual and expected temperatures may be calculated by the temperature difference calculator 520.

The z-score calculator 522 may calculate the z-score for the average temperature difference calculated by the temperature difference calculator 520. Because the temperature differences for a particular device platform or product line follow a Gaussian distribution, the z-score may be the number of standard deviations that the average temperature difference is above or below the average value for the distribution.

The z-score mapper 524 may map the z-score to a thermal health grade for the electronic device. The mapping of the z-score to a value may be accomplished using a function or a table similar to the one in FIG. 4. Higher thermal health grades may be indicative of better thermal health.

The system 500 may be used to monitor the thermal health grade of an electronic device. The thermal health grade may decrease as the thermal health of the electronic device degrades. Once the thermal health grade has fallen to a certain point, maintenance may be necessary to prevent further degradation of the thermal health of the electronic device and possible irreparable damage. Furthermore, the system 500 may be used to determine if the intervention was effective at improving the thermal health of the electronic device.

The system 500 may also include a display 526. The display 526 may be a touchscreen built into the device. For example, the touchscreen may include a touch entry system. Alternatively, the display 526 may be an interface that couples to an external display. In this example, a human machine interface may couple to input devices, such as mice, keyboards, and the like. The display 526 may show the thermal health grade of an electronic device. The display 526 may also show any of the data used to calculate the thermal health grade, e.g., from data records to z-scores. The display 526 may further display a recommendation for maintenance if the thermal health grade is at or below a predetermined threshold.

The system 500 may include an input/output (I/O) device interface 528 to connect the system 500 to one or more I/O devices 530. For example, the I/O devices 530 may include a scanner, a keyboard, and a pointing device such as a mouse, a touchpad, or touchscreen, among others. The I/O devices 530 may be built-in components of the system 500, or may be devices that are externally connected to the system 500.

The system 500 may further include a network interface controller (NIC) 532 to provide a wired communication to the cloud 534. The cloud 534 may be in communication with the data repository 518. The system 500 may communicate with the data repository 518 via the NIC 532 and the cloud 534.

The block diagram of FIG. 5 is not intended to indicate that the system for monitoring the thermal health of an electronic device is to include all of the components shown. Furthermore, the system may include any number of additional components not shown in FIG. 5, depending on the details of the specific implementation.

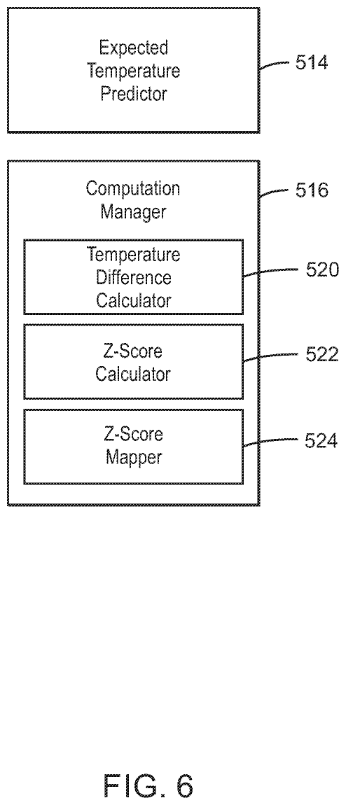

FIG. 6 is a block diagram of a system for monitoring the thermal health of an electronic device. Like numbered items are as described with respect to FIG. 5. The system may include an expected temperature predictor 514 and a computation manager 516. The computation manager 516 may include a temperature difference calculator 520, a z-score calculator 522 and a z-score mapper 524. The components shown in FIG. 6 may perform the same or similar functions as their counterparts in FIG. 5.

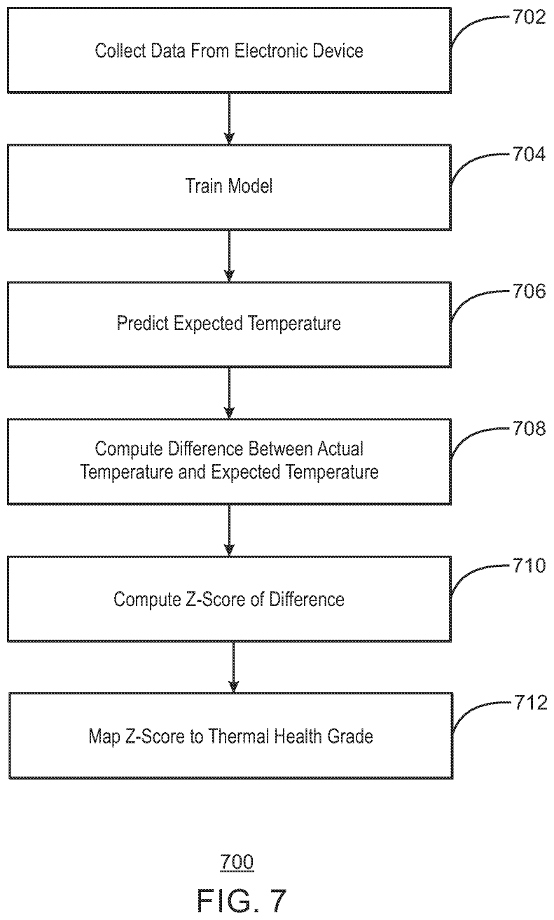

FIG. 7 is a process flow diagram of a method 700 for monitoring the thermal health of an electronic device. The method 700 may be performed by the systems shown in FIGS. 5 and 6. The method 700 may start at block 702 when data is collected from an electronic device. The data may be collected by data sensors that detect the temperature of the electronic device and other parameters that influence the thermal behavior of the device over time. The other parameters may include CPU usage, fan speed, and battery usage of the electronic device.

At block 704, a model may be trained using the data collected at block 702. Using machine learning, a model may be trained to predict the temperature of an electronic device based on CPU usage, fan speed, and battery usage. In particular, the trained model may be a random forest model. A model may be trained for each type of device platform or product line.

At block 706, the trained model may be used to predict the expected temperature of an electronic device. Inputs to the trained model may include CPU usage, fan speed, and battery usage. From these inputs, the expected temperature is predicted. The expected temperature may be predicted N times using the last N data records for a particular type of device platform or product line.

At block 708, the difference between the actual temperature and expected temperature may be computed. Each data record may include the temperature of the electronic device in addition to CPU usage, fan speed, and battery usage. The calculated difference is between the actual temperature in a data record and the expected temperature predicted using CPU usage, fan speed, and battery usage contained in the same data record. The difference between the actual temperature and expected temperature may be computed N times using the last N data records for a particular type of device platform or product line. The N differences between the actual and expected temperatures may be averaged.

At block 710, a z-score may be computed for the difference between the actual temperature and expected temperature of the electronic device. The z-score may be calculated because the temperature differences for a given type of device platform or product line follow a Gaussian distribution much like the one shown in FIG. 3. The z-score may be calculated for the average of the N differences between the actual and expected temperatures for the last N data records.

At block 712, the z-score may be mapped to a thermal health grade. The mapping of the z-score to a value may be accomplished using a function or a table similar to the one in FIG. 4. Higher thermal health grades may indicate that the electronic device is in better thermal health. Over time, the thermal health of an electronic device may degrade with a corresponding decrease in the value of the thermal health grade. Hence, the thermal health grade may be a mechanism for monitoring the thermal health of an electronic device. Furthermore, a particular thermal health grade may be chosen as the point at which maintenance should take place. In this manner, the cause of the degrading thermal health may be identified and corrected before irreparable damage occurs to the electronic device.

The process flow diagram of FIG. 7 is not intended to indicate that the method is to include all of the blocks shown. Furthermore, the method may include any number of additional blocks not shown in FIG. 7, depending on the details of the specific implementation.

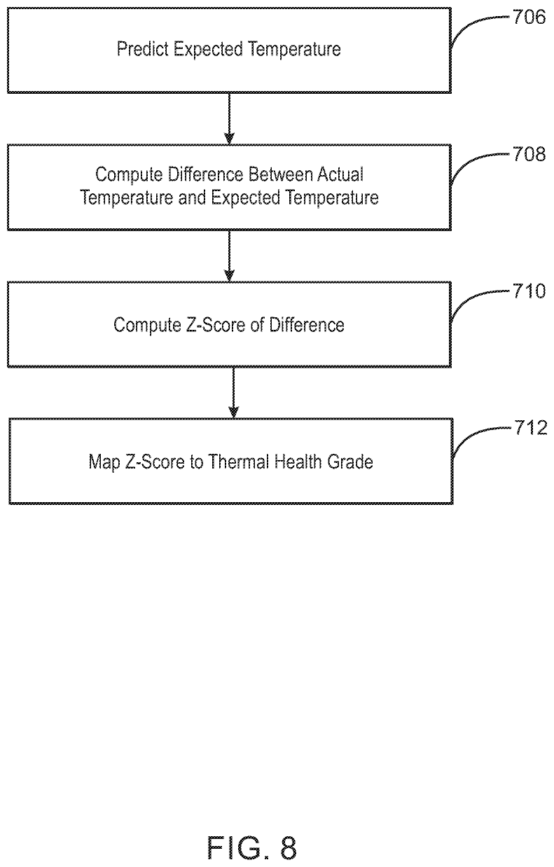

FIG. 8 is a process flow diagram of a method for monitoring the thermal health of an electronic device. Like the method 700 in FIG. 7, the method in FIG. 8 may be performed by the systems shown in FIGS. 5 and 6. The method in FIG. 8 is composed of blocks 706-712, which are the same as their counterparts in FIG. 7.

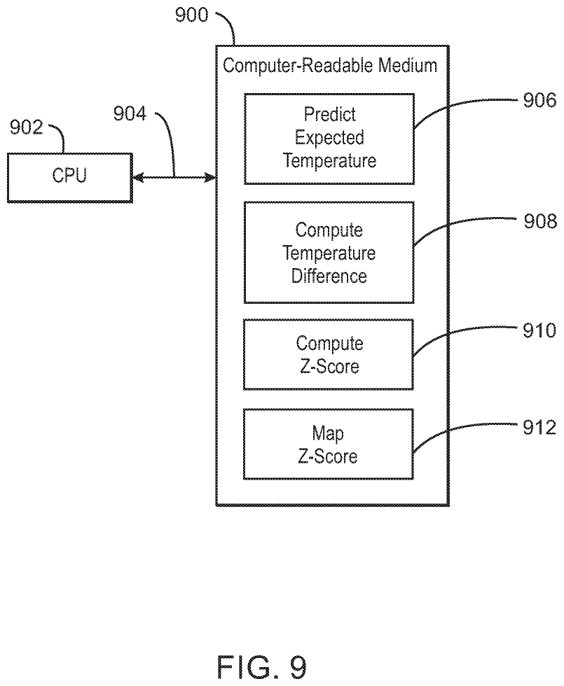

FIG. 9 is a block diagram of an exemplary non-transitory, machine-readable medium 900 including code to direct a processor 902 to monitor the thermal health of an electronic device in accordance with some embodiments. The processor 902 may access the non-transitory, machine-readable medium 900 over a bus 904. The processor 902 and the bus 904 may be selected as described with respect to the processor 502 and the bus 506 of FIG. 5. The non-transitory, machine-readable medium 900 may include devices described for the mass storage 508 of FIG. 5, or may include optical disks, thumb drives, or any number of other hardware devices.

As described herein, the non-transitory, computer-readable medium 900 may include code 906 to direct the processor 902 to predict the expected temperature using a model. Code 908 may be included to direct the processor 902 to compute the difference between the actual and expected temperature. Code 910 may be included to direct the processor 902 to compute the z-score for the difference between the actual temperature and the expected temperature. Code 912 may be included to direct the processor 902 to map the z-score to a thermal health grade for the electronic device.

The block diagram of FIG. 9 is not intended to indicate that the medium 900 is to include all of the code shown. Furthermore, the medium 900 may include additional code not shown in FIG. 9, depending on the details of the specific implementation.

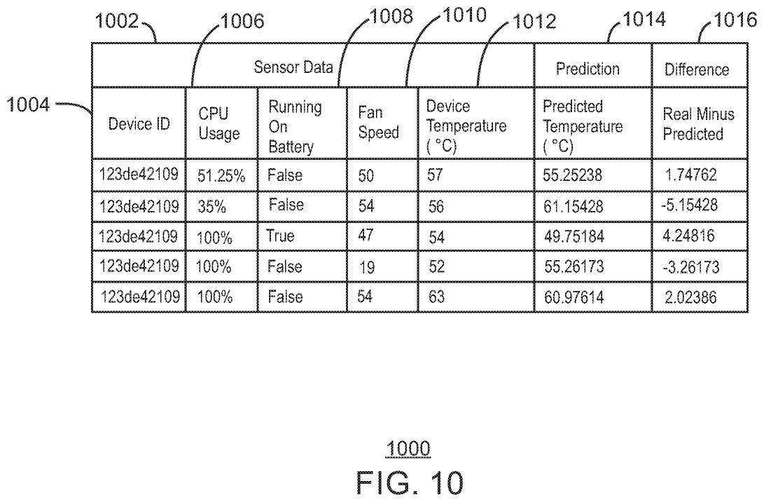

FIG. 10 is an example illustrating the use of the present techniques to predict the thermal health of a device. The table 1000 shows the sensor data 1002 for N=5 data records for the same device ID 1004. The data records include CPU usage 1006, battery usage 1008, fan speed 1010, and device temperature 1012. For each of the five data records, a model is used to estimate the predicted temperature 1014 using the CPU usage 1006, battery usage 1008, and fan speed 1010 as inputs to the model. For each of the five data records, the difference 1016 between the device temperature 1012 and the predicted temperature 1014 is calculated. The average of the differences 1016 is calculated to be x=−0.079. The Gaussian distribution for the device platform type or product line that includes the device ID 1004 has an average of μ=0.051 and a standard deviation of σ=5.125. The z-score for the average of the differences 1016 is calculated as follows:

$$\begin{matrix}z \text{-} score = ( x - µ ) \text{/} σ \\ = ( - 0.079 - 0.051 ) \text{/} 5.125 \\ = - 0.0254\end{matrix}$$

Using the table 400 in FIG. 4, the z-score of −0.0254 maps to a thermal health grade of 70 for the electronic device identified as 123de42109.

The techniques described herein may be applied to many types of electronic devices, independent of model, platform, or manufacturer. Furthermore, comparisons between models, platforms, and manufacturers may be made using the techniques described herein. The data-driven techniques have a learning component that may result in thermal models that are up-to-date. Storing of data in a large data repository may make it possible to execute machine learning in a scalable way. Scalability involves the constant addition of new data that is used to update the trained models. Trained models may be reused, thereby avoiding the need for data reprocessing. Training of the models may occur without any human intervention.

The techniques described herein may provide early detection of abnormal thermal behavior of an electronic device. A maintenance alert may be triggered, so that engineers can investigate and determine the root cause of the abnormal thermal behavior. Moreover, the techniques described herein may be used for prototyping a new electronic device. Engineers may use the techniques to train a model for the new device and compare the model to models for other electronic devices to facilitate the identification of bottlenecks in the heat dissipation of the new device.

A model may not have to be trained immediately for a new electronic device. Further, a model may be trained for a particular type of electronic device and may generalize to a new version of the electronic device. For example, a model may be trained with data from a workstation. When a new version of the workstation is released, the model may generalize to the new version without having to be retrained. However, generalization may be limited after a certain point and the model may eventually have to be retrained for the new version of the electronic device.

While the present techniques may be susceptible to various modifications and alternative forms, the examples discussed above have been shown only by way of example. It is to be understood that the techniques are not intended to be limited to the particular examples disclosed herein. Indeed, the present techniques include all alternatives, modifications, and equivalents falling within the scope of the present techniques.

What is claimed is:

1. A system for monitoring the thermal health of an electronic device, comprising:
a predictor to predict an expected temperature of the electronic device using a model; and
a computation manager to:
compute a difference between an actual temperature of the electronic device and the expected temperature;
compute a z-score of the difference; and
map the z-score to a thermal health grade for the electronic device.

2. The system of claim 1, comprising:
a data sensor to collect data from the electronic device, wherein the data is collected in a data record, and wherein the data record is stored in a data repository; and
a model trainer to train the model using the data record from the data repository.

3. The system of claim 2, wherein the model comprises a random forest model.

4. The system of claim 2, wherein the data record comprises temperature, CPU usage, fan speed, and battery usage of the electronic device.

5. The system of claim 2, wherein the model is trained for an electronic device platform, or a product line, or both.

6. The system of claim 1, wherein the thermal health grade is on a scale from 0 to 100, and wherein a higher thermal health grade indicates better thermal health.

7. A method for monitoring the thermal health of an electronic device, comprising:
predicting an expected temperature of the electronic device using a model;
computing a difference between an actual temperature of the electronic device and the expected temperature;
computing a z-score of the difference; and
mapping the z-score to a thermal health grade for the electronic device.

8. The method of claim 7, comprising:
collecting data from the electronic device, wherein the data is collected in a data record, and wherein the data record is stored in a data repository; and
training the model using the data record from the data repository.

9. The method of claim 8, wherein the model comprises a random forest model.

10. The method of claim 8, wherein the data record comprises temperature, CPU usage, fan speed, and battery usage of the electronic device.

11. The method of claim 8, comprising training the model for an electronic device platform, or a product line, or both.

12. The method of claim 7, wherein the thermal health grade is on a scale from 0 to 100, and wherein a higher thermal health grade indicates better thermal health.

13. A non-transitory, computer readable medium comprising machine-readable instructions for monitoring the thermal health of an electronic device, the instructions, when executed, direct a processor to:
predict an expected temperature of the electronic device using a model;
compute a difference between an actual temperature of the electronic device and the expected temperature;
compute a z-score of the difference; and
map the z-score to a thermal health grade for the electronic device.

14. The non-transitory, computer readable medium of claim 13, wherein the instructions when executed direct the processor to:
collect data from the electronic device, wherein the data is collected in a data record, and wherein the data record is stored in a data repository; and
train the model using the data record from the data repository.

15. The non-transitory, computer readable medium of claim 14, wherein the instructions when executed direct the processor to train the model for an electronic device platform, or product line, or both.
